(19) United States
(12) Patent Application Publication
(10) Pub. No.: US 2024/0180678 A1
(43) Pub. Date: Jun. 6, 2024

(54) Device for Dental Irrigation

(71) Applicant: Stuart Berger, Scarsdale, NY (US)

(72) Inventor: Stuart Berger, Scarsdale, NY (US)

(21) Appl. No.: 17/326,370

(22) Filed: May 21, 2021

(51) Int. Cl. A61C 17/024

(52) U.S. Cl. CPC A61C 17/024; A61C 2204/002

(57) ABSTRACT

The presently disclosed dental irrigation device projects irrigates and cleans teeth by directing fluid onto the surfaces of a user's teeth and the interproximal spaces between a user's teeth and gum line. The device comprises two hollow U-shaped manifolds that are arranged in a back to back configuration, with one manifold pointing up and one manifold pointing down. Each manifold has an orifice located on each interior face that is used as a fluid jet to irrigate surfaces between teeth and gum line. The dental irrigation device preferably is part of an overall, self-contained device that includes the dental irrigation device, a fluid source/container, a pump that provides fluid from the container to the dental irrigation device, and a dry battery, independent power source. The self-contained device allows for handheld, cords and/or tubing free use of the self-contained device and accordingly, dental irrigation device.

### CROSS REFERENCE TO RELATED APPLICATION

This application claims the benefit of U.S. Provisional Patent Application No. 63/142,049, filed Jan. 27, 2021.

### FIELD OF THE DISCLOSURE

The present disclosure relates generally to a dental hygiene device and method of use.

### BACKGROUND

Cleaning of teeth is an important part of good dental hygiene, and can help prevent tooth decay, gum disease, and bad breath. Moreover, good oral/dental hygiene has been associated with overall health and physical wellbeing. Daily cleaning of teeth is accomplished by tooth brushing, flossing, tooth picking, etc. Flossing is often a neglected part of tooth cleaning, since many find manipulation of dental floss and/or floss pickers difficult and thereby choose not to floss on a regular basis.

Accordingly, there is a need in the art for an efficient, effective, and convenient to use device and method of cleaning in between teeth. The presently disclosed oral irrigating device addresses these needs.

### SUMMARY

The disclosure presented herein relates to a device for dental irrigation that projects fluid/water onto the surfaces of a user's teeth and the interproximal spaces between a user's teeth and gum line. The device comprises two hollow U-shaped manifolds that are arranged in a back to back configuration, with one manifold pointing up and one manifold pointing down. Each manifold has an orifice located on each interior face that is used as a fluid jet to irrigate surfaces between teeth and gum line.

The manifolds are connected to a fluid inlet that supplies the fluid to the manifolds. Fluid thereby flows through the water inlet to the manifolds to provide teeth cleaning and oral irrigation via the fluid orifices/jets in the manifolds.

The device is configured to be placed in a user's mouth so as to receive the top and bottom sets of teeth in each corresponding U-shaped manifold, with orifices configured to provide water jets aligned toward the lingual and buccal sides of the teeth. A user's teeth may be cleaned with a controlled water flow by moving the device in a sweeping motion between each set of teeth on the top and bottom of the user's jaw.

In a preferred embodiment, the dental irrigation device is part of an overall, self-contained device that includes the dental irrigation device, a fluid source/container, a pump that provides fluid from the container to the dental irrigation device, and a dry battery, independent power source. The self-contained device allows for hand held, cords and/or tubing free use of the self-contained device and accordingly, dental irrigation device.

The preceding and following embodiments and descriptions are for illustrative purposes only and are not intended to limit the scope of this disclosure. Other aspects and advantages of this disclosure will become apparent from the following detailed description.

### BRIEF DESCRIPTION OF THE DRAWINGS

Embodiments of the present disclosure are described in detail below with reference to the following drawings. These and other features, aspects, and advantages of the present disclosure will become better understood with regard to the following description, and accompanying drawings. The drawings described herein are for illustrative purposes only of selected embodiments and not all possible implementations and are not intended to limit the scope of the present disclosure.

FIG. 1 is a perspective view of an embodiment of a presently disclosed device for dental irrigation.

### DETAILED DESCRIPTION

In the Summary above and in this Detailed Description, and in the accompanying drawing, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

A presently disclosed device for oral irrigation may be designed such that a controlled pressure flow of fluid is directly projected onto teeth surfaces, interproximal spaces, and gum line of a user's mouth. The apparatus may comprise two hollow manifold components having holes located on the interior faces of each manifold, and a fluid inlet joint attaching the two manifolds at a central point of reflection. The manifolds may be in a variety of different geometric configurations, such as, but not limited to, U-shaped, parabolic, or rectangular.

As used herein, the term “fluid” may refer to any type of dental irrigation and/or tooth cleaning fluid. Such fluids include, but are not limited to water, liquid dental washing fluid, mouth wash, dental rinse fluid, and the like. In a preferred embodiment, the fluid is water.

In a preferred embodiment the manifold may be described herein as a U-shaped manifold. Each U-shaped manifold may be embodied such that it fits around a user's corresponding upper and lower teeth. Although a preferred embodiment disclosed herein describes a symmetrical configuration for the apparatus, and each corresponding manifold, it should be understood that symmetry may only be approximate, and that the configuration of the manifolds and apparatus may be ergonomically designed to fit into a user's mouth, which includes asymmetry from the buccal to lingual sides, and design accommodations for overbite and/or underbite

In a preferred embodiment, the dental irrigation device may provide fluid orifices/jets aligned towards the lingual and buccal side of the user's teeth for fluid flow. A user's teeth may be cleaned by moving the apparatus over the teeth in a sweeping manner such that a sweep of the manifold from one tooth to an adjacent tooth will ensure all of the gum line and every interproximal space is cleaned with the aforementioned fluid jets

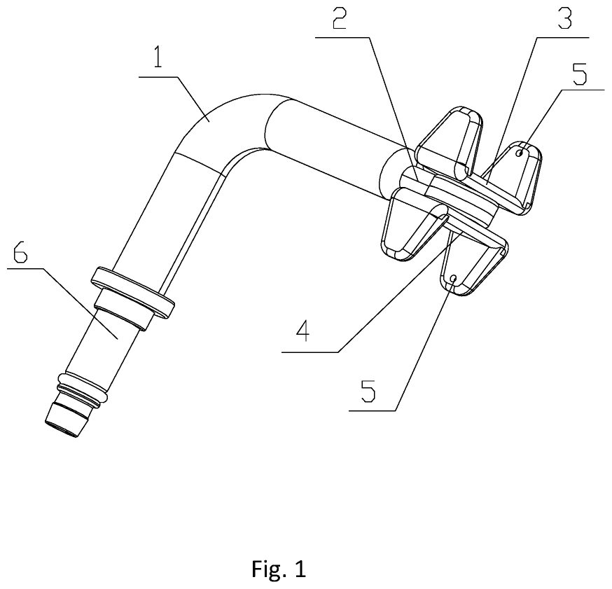

FIG. 1 illustrates a preferred embodiment of the presently disclosed device. The device may comprise two hollow U-shaped manifolds 3 and 4, wherein each parabolic or U-shaped manifold 3 or 4 is hollow and has an inner surface and an outer surface. Each U-shaped manifold 3 or 4 is hollow to allow fluid to freely fill the manifold and to be dispensed through orifices 5 in the manifold. Each U-shaped manifold 3 or 4 comprises an inlet 2 to receive fluid into its hollow interior. The inlet 2 is preferably located at or near the center on the bottom side of the U-shaped manifold 3 or 4. Such positioning provides for even fluid flow to both hollow, upper sides of the U-shaped manifold 3 or 4.

The preferred embodiment of the dental irrigation device includes manifold components 3 and 4 and inlet joint 2 that provide for free movement of the device when in use. Each manifold component 3 or 4 may be designed in a U-shape with aligned fluid orifices 5 over the buccal and lingual sides of teeth. Accordingly, the two manifolds 3 and 4 may be combined to cover both top and bottom teeth at the same time.

In a preferred embodiment, the manifolds 3 and 4 of the device each contain two aligned fluid orifices/jets 5, whereby each upper portion of the U-shaped manifold 3 or 4 preferably contains a single orifice 5. The two orifices 5 of each manifold 3 or 4 are preferably aligned such that they are located at opposing positions in the upper portions of each U-shaped manifold 3 or 4. In this manner, the aligned orifices dispense fluid towards each other when in use. This alignment allows simultaneous cleaning of both the lingual and buccal sides of the teeth.

The inlet joint 2 may be constructed in a manner to provide consistent, alternating, and/or pulsing fluid flow into each manifold 3 or 4. In one embodiment, the inlet joint 2 allows rotation of the U-shaped manifolds via a rotating inlet joint about a vertical axis of symmetry for comfortable movement across teeth. A joint may serve as a handle attaching the manifolds to enable necessary rotation.

In use, the device is swept across the user's mouth from one tooth to an adjacent tooth. As the device is swept across the user's mouth, the fluid orifices 5 of the manifolds 3 and 4 dispense fluid onto and between teeth and gums to provide dental irrigation and cleaning.

The presently disclosed device provides advantages of the aforementioned manifolds 3 and 4 over conventional devices, including, but not limited to: providing fast action when compared to single water jets, water picks, or water flossers, enabling the user to wash their mouth and floss more efficiently; providing an ability to be certain that the fluid is appropriately aimed to the appropriate portions of the user's teeth; providing ease of use when compared to single fluid jets, water picks, and manual flossing, providing assurance that teeth are thoroughly cleaned; and providing low friction movement to allow for easy movement across the tooth/gum line and to minimize any discomfort.

In addition to dental irrigation and tooth cleaning, the device may be used to massage a user's gums. The massaging of gums may be accomplished by gliding the device back and forth along the gumline.

The presently disclosed dental irrigation device requires a source of fluid to be fed into the device via an inlet tube 1. Typically, the source of fluid will have a tube or tubing that connects to the inlet tube 1 to supply fluid that is dispensed through the manifold 3 or 4 fluid orifices 5. The source of fluid will typically be pumped through tubing into the inlet tube 1 via a pump that pumps fluid from a fluid container or tank. The tubing will preferably be connected to the inlet tube 1 via a section 6 that is shaped to both receive and hold in place tubing. In this manner, tubing may be attached to the receiving section 6 to allow fluid to freely flow through the tubing into the inlet tube 1 and into the inlet joint 2, and then subsequently into manifolds 3 and 4 and then out orifices 5 to deliver fluid to a tooth.

In a preferred embodiment, the dental irrigation device is part of a self-contained overall device that includes a fluid tank/container, a fluid pump, and a power source. Preferably, the power source of the self-contained device is a dry battery that can be a standard or rechargeable battery.

In the preferred embodiment of the self-contained device, the device is designed and sized to be held in a hand of a user. In this regard, the user holds the entire device and then positions the dental irrigation device between the user's teeth for use. The self-contained device alleviates the need for a fluid tank and/or pump that stands alone, away from the dental irrigation device. Accordingly, the self-contained device conveniently allows hand held use of the device without any tubing and/or cords that are attached to the dental irrigation device.

The preferred embodiment of a self-contained device is thereby readily portable and allows the dental irrigation device to be freely used in virtually any location. As such, the self-contained device is without any constraints due to tubing, power cords, an independent fluid tank, an independent pump and so forth that would require the dental irrigation device to be tethered for use. Such a tethered situation restricts the location of the dental irrigation device and requires tubing and/or cords connected to the irrigation device, thereby making it less convenient to use. The self-contained device provides for convenient, hand-held use without hassles from tubing, cords, an independent fluid tank, a free standing pump, and so forth.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The exemplary, preferred embodiment was chosen and described in order to best explain the principles of the invention and the practical application, and to enable others of ordinary skill in the art to understand the invention for various embodiments with various modifications as are suited to the particular use contemplated. The present invention according to one or more embodiments described in the present description may be practiced with modification and alteration within the spirit and scope of the appended claims. Thus, the description is to be regarded as illustrative instead of restrictive of the present invention.

I claim:

1. A dental irrigation device comprising an inlet tube, an inlet joint, and two receiving manifolds that include 2 orifices, whereby the device is configured to allow fluid to unidirectionally and sequentially flow:
a) into the inlet tube from an exterior fluid source;
b) through the inlet tube into the inlet joint;
c) through the inlet joint into the receiving manifolds; and
d) through the receiving manifolds through the 2 orifices in the manifolds.

2. The dental irrigation device of claim 1, wherein each of the receiving manifolds comprises a U-shaped manifold having a horizontal base with two, diametrically opposed vertical portions, wherein each of the two, diametrically opposed vertical portions has a single orifice that is in turn diametrically opposed to the opposite orifice on the opposite vertical portion.

3. The dental irrigation device of claim 2, wherein the diametrically opposed orifices on a manifold are axially aligned such that an opening of each orifice is aimed at an opposing opening.

4. A fully self-contained dental irrigation device comprising:
a reservoir for holding dental cleaning fluid;
a power source;
a pump that delivers fluid from the reservoir to a cleaning portion of the device; and
a cleaning portion that comprises an inlet tube, an inlet joint, and two receiving manifolds that include 2 orifices, wherein the cleaning portion is configured to allow fluid to unidirectionally and sequentially flow:
a) into the inlet tube from the reservoir;
b) through the inlet tube into the inlet joint;
c) through the inlet joint into the receiving manifolds; and
d) through the receiving manifolds through the 2 orifices in the manifolds.

5. The fully self-contained dental irrigation device of claim 4, wherein the reservoir comprises a holding tank that is contained within a handle of the device.

6. The fully self-contained dental irrigation device of claim 4, wherein the power source is a dry battery.

7. The fully self-contained dental irrigation device of claim 4, wherein the power source is a rechargeable dry battery.

8. The fully self-contained dental irrigation device of claim 4, wherein each of the receiving manifolds comprises a U-shaped manifold having a horizontal base with two, diametrically opposed vertical portions, wherein each of the two, diametrically opposed vertical portions has a single orifice that is in turn diametrically opposed to the opposite orifice on the opposite vertical portion.

9. The fully self-contained dental irrigation device of claim 4, wherein the diametrically opposed orifices on a manifold are axially aligned such that an opening of each orifice is aimed at an opposing opening.

10. The fully self-contained dental irrigation device of claim 4, wherein the device is a handheld, portable device.

11. A fully self-contained dental irrigation device consisting of:
a reservoir for holding dental cleaning fluid;
a power source;
a pump that delivers fluid from the reservoir to a cleaning portion of the device; and
a cleaning portion that comprises an inlet tube, an inlet joint, and two receiving manifolds that include 2 orifices, wherein the cleaning portion is configured to allow fluid to unidirectionally and sequentially flow:
a) into the inlet tube from the reservoir;
b) through the inlet tube into the inlet joint;
c) through the inlet joint into the receiving manifolds; and
d) through the receiving manifolds through the 2 orifices in the manifolds.

12. The fully self-contained dental irrigation device of claim 11, wherein the reservoir consists of a holding tank that is contained within a handle of the device.

13. The fully self-contained dental irrigation device of claim 11, wherein the power source is a dry battery.

14. The fully self-contained dental irrigation device of claim 11, wherein the power source is a rechargeable dry battery.

15. The fully self-contained dental irrigation device of claim 11, wherein each of the receiving manifolds consists of a U-shaped manifold having a horizontal base with two, diametrically opposed vertical portions, wherein each of the two, diametrically opposed vertical portions has a single orifice that is in turn diametrically opposed to the opposite orifice on the opposite vertical portion.

16. The fully self-contained dental irrigation device of claim 11, wherein the diametrically opposed orifices on a manifold are axially aligned such that an opening of each orifice is aimed at an opposing opening.

17. The fully self-contained dental irrigation device of claim 11, wherein the device is a handheld, portable device.
